(19) United States
(12) Patent Application Publication
(10) Pub. No.: US 2026/0084358 A1
(43) Pub. Date: Mar. 26, 2026

(54) METHODS FOR PRODUCING LIQUID CRYSTAL POLYMER FILAMENTS

(71) Applicant: KURARAY CO., LTD., Kurashiki-shi (JP)

(72) Inventors: Patrick COFFEY, Fort Mill, SC (US); Forrest SLOAN, Blacksburg, VA (US); Matthew REID, Gaffney, SC (US); Taichi YAGATA, Saijo-shi (JP); Tatsuya UEDA, Kurashiki-shi (JP); Kazuhisa NAKAYAMA, Saijo-shi (JP)

(73) Assignee: KURARAY CO., LTD., Kurashiki-shi (JP)

(21) Appl. No.: 19/336,649

(22) Filed: Sep. 23, 2025

Related U.S. Application Data
(60) Provisional application No. 63/698,227, filed on Sep. 24, 2024.

(51) Int. Cl. B29C 48/05; B29C 48/00; B29C 48/40; B29K 67/00; B29K 105/00

(52) U.S. Cl. CPC B29C 48/05; B29C 48/022; B29C 48/40; B29K 2067/06; B29K 2105/0079

(57) ABSTRACT

Disclosed herein are methods for producing recycled liquid crystal polymer filaments. The methods include feeding one or more used liquid crystal polymer filaments, optionally in combination with a virgin liquid crystal polymer material, and optionally in combination with a depolymerization catalyst, into an extruder; and extruding the recycled liquid crystal polymer filament.

### TECHNICAL FIELD

This disclosure relates to methods for producing liquid crystal polymer (LCP) filaments in general and more specifically to methods for producing LCP filaments by recycling used LCP filaments. More particularly, this disclosure describes methods for producing recycled LCP filaments by feeding one or more used LCP filaments, optionally in combination with a virgin LCP material, into an extruder; and extruding recycled LCP filaments. This disclosure also describes methods for producing recycled LCP filaments by feeding one or more used LCP filaments, a depolymerization catalyst, and optionally a virgin LCP material, into an extruder; and extruding recycled LCP filaments.

### BACKGROUND

Recycling of polymer materials remains an important area of research and development. Broadly speaking, such recycling can be characterized as either mechanical recycling or chemical recycling. Mechanical recycling involves recovering polymer waste by mechanical processes such as sorting, washing, drying, grinding, regranulating and compounding. In contrast, chemical recycling involves partially or completely depolymerizing the polymer to form its constitutive monomers or derivates thereof.

Mechanical recycling of polymer materials generally is less expensive than chemical recycling. However, a disadvantage of mechanical recycling is usually a reduction in the quality of the recycled polymer compared to virgin (non-recycled) polymer. For example, mechanical recycling can reduce the molecular weight and/or viscosity of the polymer, due to polymer scission during melt-processing, leading to weaker mechanical properties of the recycled polymer. For this reason, mechanically recycled polymers often are limited to lower-end applications than their counterpart virgin polymers (i.e., “down-cycling”).

Although chemical recycling of polymer materials theoretically could result in recycled polymers having similar mechanical properties to their counterpart virgin polymers, chemical recycling faces its own challenges. For example, effective depolymerization of the polymer, and purification of the resulting monomer(s) for feedstocks, are time- and energy-intensive processes. The cost of these processes can make such recycled feedstocks less economically viable than virgin feedstocks.

In view of the ongoing challenges with both mechanical and chemical recycling of polymers, there remains a need for improvements in polymer recycling.

### SUMMARY OF THE DISCLOSURE

The following disclosure describes methods for producing recycled LCP filaments by feeding one or more used LCP filaments, optionally in combination with a virgin LCP material, and optionally in combination with a depolymerization catalyst, into an extruder, and extruding the recycled LCP filaments.

Specifically, embodiments of the present disclosure, described herein such that a person of ordinary skill in this art can make and use them, include methods for producing a recycled LCP filament, comprising:
feeding one or more used LCP filaments, optionally in combination with a virgin LCP material, and optionally in combination with a depolymerization catalyst, into an extruder; and
extruding the recycled LCP.

Additional embodiments of the present disclosure include recycled LCP filaments produced by such methods.

Additional objects, advantages and other features of the present disclosure will be set forth in part in the description that follows and in part will become apparent to those having ordinary skill in the art upon examination of the following or may be learned from the practice of the present disclosure. The present disclosure encompasses other and different embodiments from those specifically described below, and the details herein are capable of modifications in various respects without departing from the present disclosure. In this regard, the description herein is to be understood as illustrative in nature, and not as restrictive.

### DETAILED DESCRIPTION

Embodiments of this disclosure include various methods for producing recycled LCP filaments, and the recycled LCP filaments produced by such methods.

Unless otherwise defined, all technical and scientific terms used herein have the same meaning as commonly understood by persons of ordinary skill in the relevant art. In case of conflict, the present specification, including definitions, will control.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure is to be limited to the specific values recited when defining a range.

The use of “a” or “an” to describe the various elements and components herein is merely for convenience and to give a general sense of the disclosure. This description should be read to include one or at least one and the singular also includes the plural unless it is clear that it is otherwise intended.

Unless expressly stated to the contrary, “or” and “and/or” refers to an inclusive and not to an exclusive. For example, a condition “A or B”, or “A and/or B”, is satisfied by any one of the following: A is true (or present) and B is false (or not present), A is false (or not present) and B is true (or present), and both A and B are true (or present).

The term “substantially” as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

Throughout the present description, unless otherwise defined and described, technical terms and methods employed to determine associated measurement values are in accordance with the descriptions of ASTM D855/D885M-10A (2014), Standard Test Methods for Tire Cords, Tire Cord Fabrics, and Industrial Filament Yarns Made From Man-made Organic-base Fibers, published October 2014; IEC 60794-1-21-E1 (Optical Fiber Cables) Tensile Properties, published March 2015; and ISO 11357-3, published March 2018.

For convenience, many elements of the various embodiments disclosed herein are discussed separately. Although lists of options may be provided and numerical values may be in ranges, the present disclosure should not be considered as being limited to the separately described lists and ranges. Unless stated otherwise, each and every combination possible within the present disclosure should be considered as explicitly disclosed for all purposes.

The materials, methods, and examples herein are illustrative only and, except as specifically stated, are not intended to be limiting. Methods and materials similar to or equivalent to those described herein may also be used in the practice or testing of the present disclosure.

The LCP in the methods herein may include a thermotropic LCP, a lyotropic LCP, or a mixture of both. The LCP may include two or more kinds of the same type of LCP, for example two or more kinds of thermotropic LCP or two or more kinds of lyotropic LCP. Lyotropic polymers decompose before melting but form liquid crystals in solution under appropriate conditions (these polymers typically are solution spun). Lyotropic polymers include, for example, aramids and poly(p-phenylene benzobisoxazole) (PBO), as well as copolymer aramids. Thermotropic polymers exhibit liquid crystal formation in the melt state. Thermotropic polymers include, for example, an aromatic polyester formed by the polycondensation of 4-hydroxybenzoic acid and 6-hydroxynaphthalene-2-carboxylic acid, commercially available under the tradename Laperos® from Polyplastics.

Polymerized units of the LCP may include those shown in Table 1.

TABLE 1

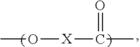

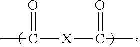

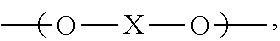

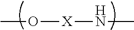

(in which X in the formulas is selected from the following structures)

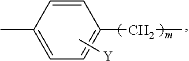

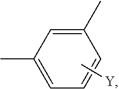

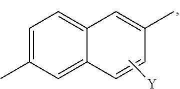

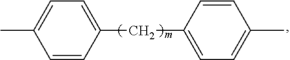

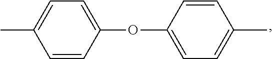

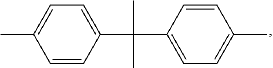

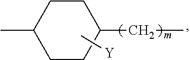

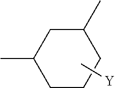

(in which m = 0 to 2, and Y = a substituent selected from a hydrogen atom, a
halogen atom, an alkyl group, an aryl group, an aralkyl group, an alkoxy group, an
aryloxy group, and an aralkyloxy group)

Regarding the polymerized units illustrated in Table 1 above, the number of Y substituent groups is equal to the maximum number of substitutable positions in the ring structure, and each Y independently represents a hydrogen atom, a halogen atom (for example, a fluorine atom, a chlorine atom, a bromine atom, an iodine atom, etc.), an alkyl group (for example, an alkyl group having 1 to 4 carbon atoms such as a methyl group, an ethyl group, an isopropyl group, or a t-butyl group), an alkoxy group (for example, a methoxy group, an ethoxy group, an isopropoxy group, an n-butoxy group, etc.), an aryl group (for example, a phenyl group, a naphthyl group, etc.), an aralkyl group [a benzyl group (a phenylmethyl group), a phenethyl group (a phenylethyl group), etc.], an aryloxy group (for example, a phenoxy group, etc.), an aralkyloxy group (for example, a benzyloxy group, etc.), or mixtures thereof.

The LCP may be composed of a repeating polymerized unit, for example, derived from an aromatic diol, an aromatic dicarboxylic acid, or an aromatic hydroxycarboxylic acid. The LCP may optionally further comprise a polymerized unit derived from an aromatic diamine, an aromatic hydroxyamine, and/or an aromatic aminocarboxylic acid.

More specific polymerized units are illustrated in the following structures shown in Tables 2 to 4 below.

When the polymerized unit in the formulas is a unit which can represent plural structures, two or more units may be used in combination as polymerized units constituting a polymer.

In the polymerized units of Tables 2, 3, and 4, n is an integer of 1 or 2, and the respective units n=1, n=2 may exist alone or in combination; and Y1 and Y2 each independently may be a hydrogen atom, a halogen atom (for example, a fluorine atom, a chlorine atom, a bromine atom, an iodine atom, etc.), an alkyl group (for example, an alkyl group having 1 to 4 carbon atoms such as a methyl group, an ethyl group, an isopropyl group, or a t-butyl group), an alkoxy group (for example, a methoxy group, an ethoxy group, an isopropoxy group, an n-butoxy group, etc.), an aryl group (for example, a phenyl group, a naphthyl group, etc.), an aralkyl group (a benzyl group (a phenylmethyl group), a phenethyl group (a phenylethyl group), etc.), an aryloxy group (for example, a phenoxy group, etc.), an aralkyloxy group (for example, a benzyloxy group, etc.), or mixtures thereof. Among these groups, Y is preferably a hydrogen atom, a chlorine atom, a bromine atom, or a methyl group.

TABLE 2

| | |
|---|---|
| 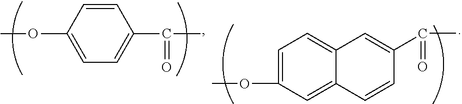 | (1) |
| 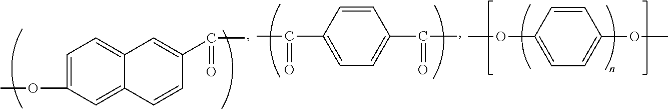 | (2) |
| 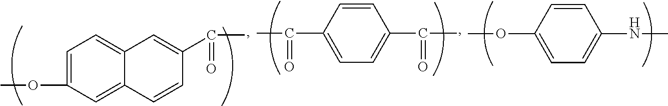 | (3) |
| 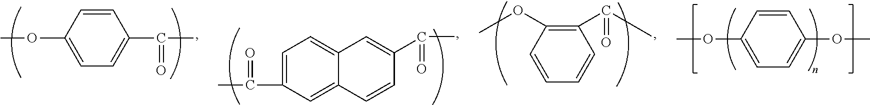 | (4) |
| 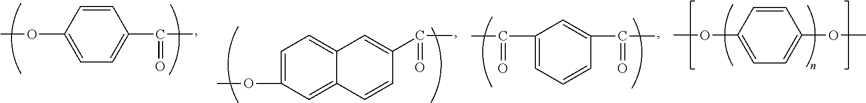 | (5) |
| 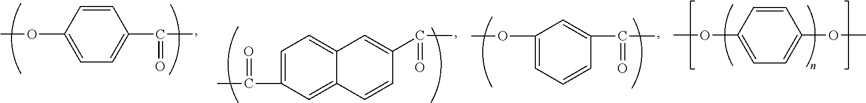 | (6) |
| 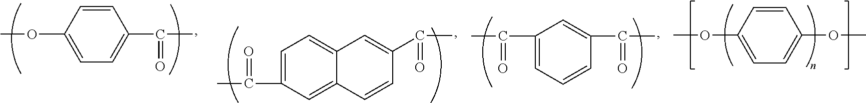 | (7) |
| 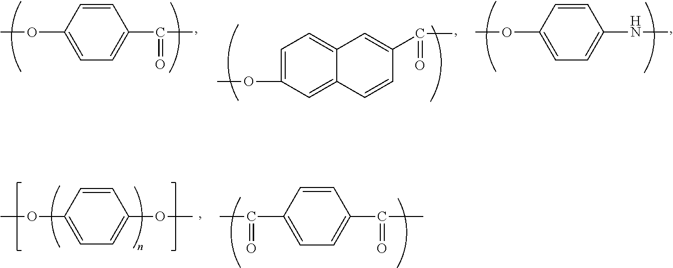 | (8) |

TABLE 3

| | |
|---|---|
| 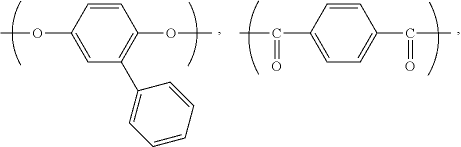 | (9) |
| 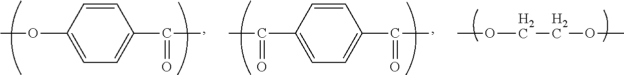 | (10) |
| 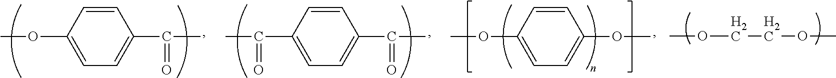 | (11) |
| 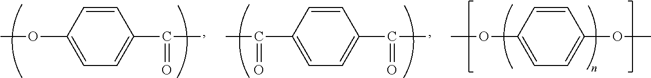 | (12) |
| 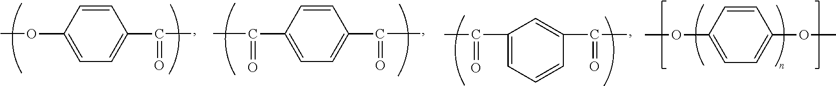 | (13) |
| 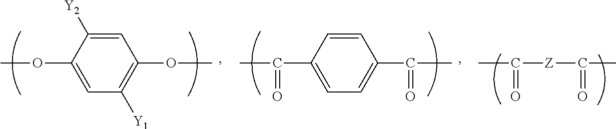 | (14) |
| 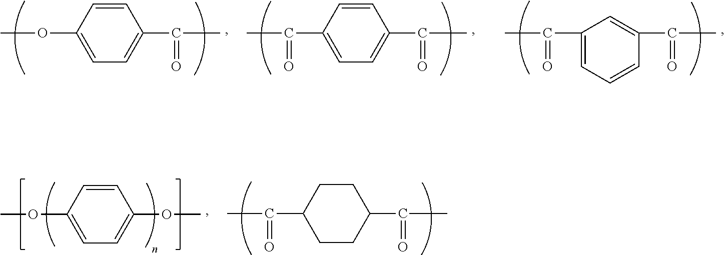 | (15) |

TABLE 4

| | |
|---|---|
| 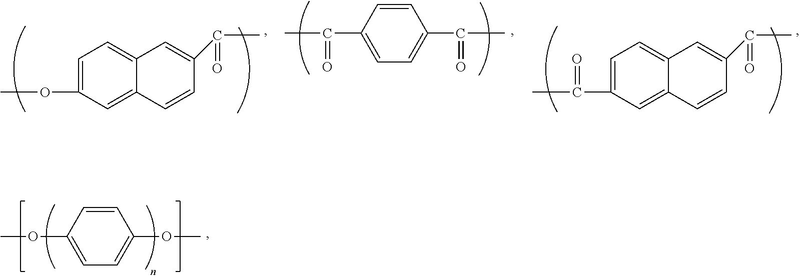 | (16) |
| 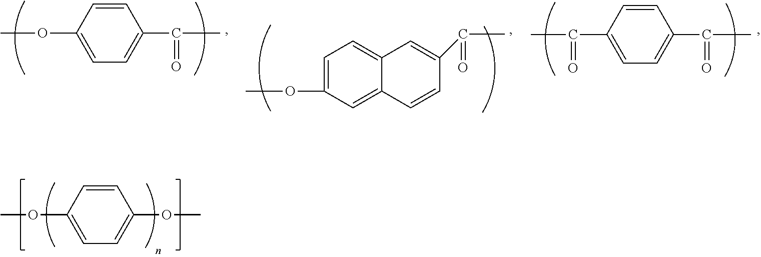 | (17) |
| 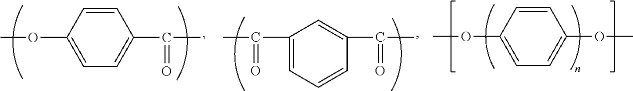 | (18) |

Z in (14) of Table 3 may comprise divalent groups represented by the formulae below:

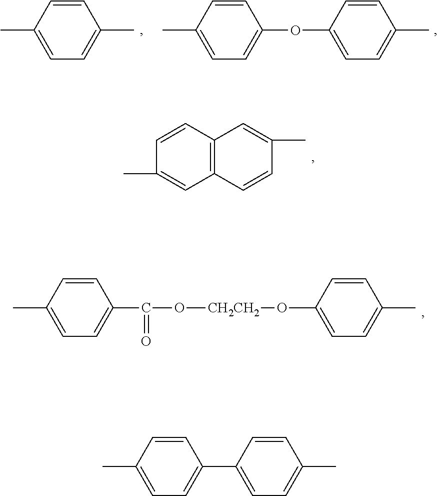

In some embodiments an LCP may be a combination comprising a naphthalene skeleton as a polymerized unit. Particularly, it may include both a polymerized unit (A) derived from 4-hydroxybenzoic acid and a polymerized unit (B) derived from 6-hydroxynaphthalene-2-carboxylic acid. For example, the unit (A) may be of formula (A) and the unit (B) may be of formula (B). From the viewpoint of improving melt moldability, a ratio of the units (A) to the units (B) may be in a range of from 9/1 to 1/1, preferably 7/1 to 1/1, and more preferably 5/1 to 1/1.

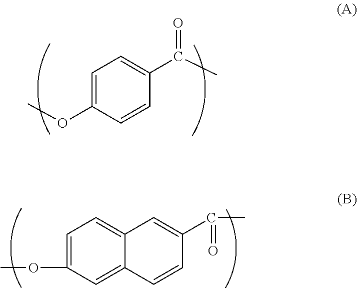

The total of the polymerized units (A) and the polymerized units (B) may be, for example, about 65 mol % or more, or about 70 mol % or more, or about 80 mol % or more, based on the total polymerized units. In some embodiments the filaments may include a liquid crystalline polyester comprising about 4 to about 45 mol % of the polymerized unit (B) in the polymer.

Commercially available LCP polymers of the present disclosure may include for example Vectra® and Zenite® manufactured by Celanese, Laperos® manufactured by Polyplastics, Sumikasuper® manufactured by Sumitomo, Xydar® manufactured by Solvay, and Siveras™ manufactured by Toray.

In the present disclosure, “used LCP filaments” in the broadest sense means LCP filaments that already have been produced. This includes, for example, LCP filaments that have been woven (either as a monofilament fiber or a multi-filament fiber) into a fabric that has been made into a garment or article, and the garment or article is used by a consumer. In this case, such used LCP filaments sometimes are characterized as post-consumer waste filaments (or post-consumer waste fibers). However, the term “used LCP filaments” also encompasses LCP filaments that have been produced but that have not been woven into a fabric or otherwise made into a garment or article. This includes, for example, a relatively small amount of an LCP filament remaining on a bobbin after a relatively large amount of the LCP filament originally on the bobbin has been removed in a process of producing a multi-filament fiber or a woven fabric. In such a situation, the relatively small amount of the LCP filament remaining on the bobbin after the production run would qualify as a used LCP filament; it could, for example, be returned to the supplier or manufacturer to be recycled according to methods of the present disclosure. In this case, such used LCP filaments sometimes are characterized as post-industrial waste filaments (or post-industrial waste fibers).

Thus, in some embodiments of the present disclosure, the used LCP filaments are LCP filaments that have been produced but that have not been woven into a fabric. These embodiments also include situations where the used LCP filaments are LCP filaments that have been produced but that have not been braided or twisted into a multi-filament fiber. In other embodiments, the used LCP filaments are filaments that have been woven into a fabric (either woven into the fabric as monofilament fibers or as multi-filament fibers), where the fabric may or may not have been made into a garment or article. Such a garment or article need not have been actually used by a consumer for the constitutive LCP filaments to be considered as used LCP filaments within the meaning of the present disclosure.

In contrast to the used LCP filaments described above, in the present disclosure “virgin LCP material” means LCP material that has not yet been formed into a filament. Typically, such virgin LCP material is in the form of one or more pellets suitable for feeding into an extruder.

In the context of the present disclosure, the term “recycled LCP filament” means an LCP filament that has been produced from one or more used LCP filaments, optionally in combination with a virgin LCP material.

The amount of the used LCP filament(s) in the recycled LCP filament can be at least 1 wt %, at least 2 wt %, at least 3 wt %, at least 4 wt %, at least 5 wt %, at least 6 wt %, at least 7 wt %, at least 8 wt %, at least 9 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or even 100 wt %, in each case based on the weight of the recycled LCP filament. In some embodiments, the amount of the used LCP filament(s) in the recycled LCP filament can be at most 1 wt %, at most 2 wt %, at most 3 wt %, at most 4 wt %, at most 5 wt %, at most 6 wt %, at most 7 wt %, at most 8 wt %, at most 9 wt %, at most 10 wt %, at most 15 wt %, at most 20 wt %, at most 25 wt %, at most 30 wt %, at most 35 wt %, at most 40 wt %, at most 45 wt %, at most 50 wt %, at most 55 wt %, at most 60 wt %, at most 65 wt %, at most 70 wt %, at most 75 wt %, at most 80 wt %, at most 85 wt %, at most 90 wt %, or at most 95 wt %, in each case based on the weight of the recycled LCP filament.

Correspondingly, the amount of virgin LCP material in the recycled LCP filament can be at most 99 wt %, at most 98 wt %, at most 97 wt %, at most 96 wt %, at most 95 wt %, at most 94 wt %, at most 93 wt %, at most 92 wt %, at most 91 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 5 wt %, or even 0 wt %, in each case based on the weight of the recycled LCP filament. In some embodiments, the amount of the virgin LCP material in the recycled LCP filament can be at least 1 wt %, at least 2 wt %, at least 3 wt %, at least 4 wt %, at least 5 wt %, at least 6 wt %, at least 7 wt %, at least 8 wt %, at least 9 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt %, in each case based on the weight of the recycled LCP filament.

The relative amounts of the used LCP filament(s) and the virgin LCP material can be controlled during extrusion of the recycled LCP filament. For example, the feed ratio, such as a mass feed ratio, between the used LCP filament(s) and the virgin LCP material fed into an extruder, can be controlled to obtain desired relative amounts of the used LCP filament(s) and the virgin LCP material in the recycled LCP filament obtained by extrusion.

The mass feed ratio of the one or more used LCP filaments to the virgin LCP material can be in a range of 1:99 to 99:1. In some embodiments, the lower limit of the mass feed ratio is at least 2:98, at least 3:97, at least 4:96, at least 5:95, at least 6:94, at least 7:93, at least 8:92, at least 9:91, at least 10:90, at least 15:85, at least 20:80, at least 25:75, at least 30:70, at least 35:65, at least 40:60, at least 45:55, at least 50:50, at least 55:45, at least 60:40, at least 65:35, at least 70:30, at least 75:25, at least 80:20, at least 85:15, at least 90:10, or at least 95:5. In some embodiments, the upper limit of the mass feed ratio is at most 2:98, at most 3:97, at most 4:96, at most 5:95, at most 6:94, at most 7:93, at most 8:92, at most 9:91, at most 10:90, at most 15:85, at most 20:80, at most 25:75, at most 30:70, at most 35:65, at most 40:60, at most 45:55, at most 50:50, at most 55:45, at most 60:40, at most 65:35, at most 70:30, at most 75:25, at most 80:20, at most 85:15, at most 90:10, or at most 95:5.

Extrusion of polymeric materials is generally known to a person of ordinary skill in this art. An extruder typically includes a barrel, one or more screws arranged as shafts inside the barrel, and one or more heater bands around the barrel. Heating of a polymer material during extrusion tends to reduce the viscosity of the polymer, allowing the polymer material to be pushed through a die or spinneret containing a hole to make a filament or a plurality of filaments. In some embodiments, the extruder temperature can be in a range of 200 to 350° C., 210 to 340° C., 220 to 330° C., 230 to 320° C., 240 to 310° C., 250 to 300° C., 260 to 290° C., or 270 to 280° C.

Advantageously, the used LCP filaments that are fed into the extruder according to the present disclosure do not get tangled or otherwise stuck in the screw(s) of the extruder. To reduce the risk of such tangling or sticking, the one or more used LCP filaments have a length of less than a circumferential length of a screw shaft of the extruder. That is, the used LCP filament(s) have a length that is less than the circumference of the shaft of the screw of the extruder. In some embodiments, the used LCP filament(s) have a length of 90% or less of the circumferential length of the screw shaft, a length of 80% or less, a length of 70% or less, a length of 60% or less, a length of 50% or less, a length of 40% or less, a length of 30% or less, a length of 20% or less, or a length of 10% or less than the circumferential length of the screw shaft. If the extruder has more than one screw (e.g., a twin-screw extruder), and one screw happens to have a smaller shaft circumference than the other screw(s), then the “circumferential length of the screw shaft” mentioned above is that of the smaller (or smallest) screw.

In addition to the used LCP filament(s) and the (optional) virgin LCP material, in some embodiments a catalyst may be fed into the extruder during extrusion. Such a catalyst may be a depolymerization catalyst that facilitates partial or complete depolymerization of the used LCP filament(s) within the extruder. Such a catalyst may be particularly advantageous when the used LCP filament(s) have previously been heat treated prior to being fed into the extruder. For example, some LCP filament(s) are heat treated during their initial production to improve their mechanical properties, such as strength or tenacity. When such LCP filament(s) are utilized as the used LCP filament(s) according to methods of the present disclosure, the methods may benefit from feeding a depolymerization catalyst along with the used LCP filament(s) into the extruder.

Accordingly, in some embodiments a depolymerization catalyst is fed into the extruder along with the used LCP filament(s) and (optional) virgin LCP material, and a recycled LCP filament is extruded. In such embodiments, the used LCP filament(s) may have been heat treated at some time prior to being fed into the extruder (such as during their initial production). Such used LCP filaments may have been heat treated at a temperature of 180° C. or above, 190° C. or above, 200° C. or above, 210° C. or above, 220° C. or above, 230° C. or above, 240° C. or above, or 250° C. or above, prior to being fed into the extruder. The upper limit of such heat treating may be 300° C., 290° C., 280° C., 270° C., 260° C., 250° C., 240° C., 230° C., 220° C., 210° C., 200° C., or 190° C.

Alternatively, in some embodiments the used LCP filament(s) and (optional) virgin LCP material are fed into the extruder without a depolymerization catalyst, or even without any catalyst. Such a catalyst may be unnecessary when the used LCP filament(s) have not previously been heat treated prior to being fed into the extruder. For example, some LCP filament(s) are not heat treated during their initial production to improve their mechanical properties, such as strength or tenacity. When such LCP filament(s) are utilized as the used LCP filament(s) according to methods of the present disclosure, the methods may not substantially benefit from feeding a depolymerization catalyst along with the used LCP filament(s) into the extruder.

Accordingly, in some embodiments no depolymerization catalyst, or no catalyst at all, is fed into the extruder along with the used LCP filament(s) and (optional) virgin LCP material, and a recycled LCP filament is extruded. In such embodiments, the used LCP filament(s) may not have been heat treated at some time prior to being fed into the extruder (such as during their initial production), or more precisely may not have been heat treated above a certain specified temperature. For example, such used LCP filaments may not have been heat treated at a temperature of 300° C. or above, 290° C. or above, 280° C. or above, 270° C. or above, 260° C. or above, 250° C. or above, 240° C. or above, 230° C. or above, 220° C. or above, 210° C. or above, 200° C. or above, 190° C. or above, or 180° C. or above, prior to being fed into the extruder.

When included in methods according to the present disclosure, a suitable depolymerization catalyst is known to those of ordinary skill in the art. Such a catalyst generally has condensation activity, for example catalyzing a condensation reaction to form a bond between components (e.g., monomers or polymer chains) while producing a water byproduct and/or catalyzing an exchange reaction between components (e.g., monomers or polymer chains) to break and re-form condensation bonds. For example, for a polyester polymer, the catalyst can have one or both of condensation activity and transesterification activity, and for a polyamide polymer, the catalyst can have one or both of condensation activity and transamidation activity.

In some embodiments, the depolymerization catalyst is selected from the group consisting of metal alkanoates, metal benzoates, metal carbonates, metal sulfates, acids, bases, and combinations thereof. Suitable metals in the various catalysts can include zinc, zirconium, titanium, sodium, potassium, etc. Example metal alkanoates include zinc acetate, zinc ethylhexanoate, and zinc fluoroacetate. Example metal benzoates include zinc benzoate, zinc chlorobenzoate, zinc bromobenzoate, zinc nitrobenzoate, and zinc methoxy benzoate. Example metal sulfates include sodium sulfate and potassium sulfate. Example metal carbonates include sodium carbonate and potassium carbonate. Example acid catalysts include sulfuric acid and sulfonic acid derivatives. Example bases include metal hydroxides such as sodium hydroxide and potassium hydroxide.

In some embodiments, the depolymerization catalyst can be an organic base, for example selected from organic compounds which are metal-free or substantially metal-free. Suitable organic catalysts include 1,5,7-triazabicyclo[4.4.0]dec-5-ene (TBD) and 1,8-diazabicyclo[5.4.0]undec-7-ene (DBU).

When present, the depolymerization catalyst can be present in an amount of at least 0.1 wt %, at least 0.2 wt %, at least 0.3 wt %, at least 0.4 wt %, at least 0.5 wt %, at least 1.0 wt %, at least 2.0 wt %, at least 3.0 wt %, at least 4.0 wt %, at least 5.0 wt %, at least 10 wt %, at least 15 wt %, or at least 20 wt %, in each case relative to the total amount of depolymerization catalyst, used LCP filament(s), and (optional) virgin LCP material fed into the extruder. The upper limit of the amount of depolymerization catalyst may be 20 wt %, 15 wt %, 10 wt %, 5.0 wt %, 4.0 wt %, 3.0 wt %, 2.0 wt %, 1.0 wt %, 0.5 wt %, 0.4 wt %, 0.3 wt %, or 0.2 wt %.

In some embodiments, including both situations where a depolymerization catalyst is employed or not employed, the used LCP filament(s) retain a relatively high degree of crystallinity during the extrusion. In particular, the used LCP filament(s) may retain a crystalline polymer content of at least 30 wt %, at least 40 wt %, at least 50 wt %, at least 60 wt %, at least 70 wt %, at least 80 wt %, at least 90 wt %, or even 100 wt %.

Similarly, when employed in the methods of the present disclosure, the (optional) virgin LCP material may retain a relatively high degree of crystallinity during the extrusion, such as a crystalline polymer content of at least 30 wt %, at least 40 wt %, at least 50 wt %, at least 60 wt %, at least 70 wt %, at least 80 wt %, at least 90 wt %, or even 100 wt %.

As a result, the recycled LCP filament produced by methods according to the present disclosure may have a relatively high degree of crystallinity after the extrusion, such as a crystalline polymer content of at least 30 wt %, at least 40 wt %, at least 50 wt %, at least 60 wt %, at least 70 wt %, at least 80 wt %, at least 90 wt %, or even 100 wt %.

### EMBODIMENTS

Embodiment [1] of the present disclosure relates to a method for producing a recycled liquid crystal polymer filament, comprising:
feeding one or more used liquid crystal polymer filaments, optionally in combination with a virgin liquid crystal polymer material, into an extruder; and
extruding the recycled liquid crystal polymer filament.

Embodiment [2] of the present disclosure relates to the method of Embodiment [1], wherein a catalyst is not fed into the extruder during the extruding of the recycled liquid crystal polymer filament.

Embodiment [3] of the present disclosure relates to the method of Embodiment [1] or [2], wherein the virgin liquid crystal polymer material is fed into the extruder in combination with the one or more used liquid crystal polymer filaments.

Embodiment [4] of the present disclosure relates to the method of Embodiment [3], wherein a mass feed ratio of the one or more used liquid crystal polymer filaments to the virgin liquid crystal polymer material is in a range of 1:99 to 99:1.

Embodiment [5] of the present disclosure relates to the method of Embodiment [3] or [4], wherein the virgin liquid crystal polymer material is fed into the extruder in the form of one or more pellets.

Embodiment [6] of the present disclosure relates to the method of any one of Embodiments [1] to [5], wherein the one or more used liquid crystal polymer filaments have not been heat treated at a temperature of 250° C. or above prior to being fed into the extruder.

Embodiment [7] of the present disclosure relates to the method of any one of Embodiments [1] to [6], wherein the one or more used liquid crystal polymer filaments have a length of 50% or less of a circumferential length of a screw shaft of the extruder.

Embodiment [8] of the present disclosure relates to a method for producing a recycled liquid crystal polymer filament, comprising:
feeding into an extruder (a) one or more used liquid crystal polymer filaments, (b) a depolymerization catalyst, and (c) optionally a virgin liquid crystal polymer material; and
extruding the recycled liquid crystal polymer filament.

Embodiment [9] of the present disclosure relates to the method of Embodiment [8], wherein the virgin liquid crystal polymer material is fed into the extruder in combination with the one or more used liquid crystal polymer filaments and the depolymerization catalyst.

Embodiment [10] of the present disclosure relates to the method of Embodiment [9], wherein a mass feed ratio of the one or more used liquid crystal polymer filaments to the virgin liquid crystal polymer material is in a range of 1:99 to 99:1.

Embodiment [11] of the present disclosure relates to the method of Embodiment [9] or [10], wherein the virgin liquid crystal polymer material is fed into the extruder in the form of one or more pellets.

Embodiment [12] of the present disclosure relates to the method of any one of Embodiments [8] to [11], wherein the one or more used liquid crystal polymer filaments have been heat treated at a temperature of 180° C. or above prior to being fed into the extruder.

Embodiment [13] of the present disclosure relates to the method of any one of Embodiments [8] to [12], wherein the one or more used liquid crystal polymer filaments have a length of 50% or less of a circumferential length of a screw shaft of the extruder.

Embodiment [14] of the present disclosure relates to a recycled liquid crystal polymer filament produced by the method of any one of Embodiments [1] to [13].

### EXAMPLES

Production of Liquid Crystal Polyester Fiber that has not been Heat Treated at a Temperature of 250° C. Or Above

Pellets of a melt-anisotropic aromatic polyester having constituent units (A) and (B) were fed into a twin-screw extruder, kneaded at a temperature of 200 to 400° C., and melt-spun to obtain a 1670 dtex/300f fiber. The constituent units (A) were derived from 4-hydroxybenzoic acid, and the constituent units (B) were derived from 6-hydroxy-2-naphthoic acid. The melt-anisotropic aromatic polyester contained the constituent units (A) and (B) in a molar ratio of 73 mol % (A) to 27 mol % (B). The resulting fiber was a liquid crystalline polyester fiber that was not heat treated at a temperature of 250° C. or above. The melting point of this fiber was 280° C. In the examples that follow, this fiber was employed as the used liquid crystal polymer filament(s).

### Example 1

The above liquid crystalline polyester fiber that had not been heat treated at a temperature of 250° C. or above (i.e., the used liquid crystal polymer filament(s)) was fed into a twin-screw extruder together with pellets of a virgin liquid crystal polymer material. The virgin liquid crystal polymer material also was a melt-anisotropic aromatic polyester having constituent units (A) derived from 4-hydroxybenzoic acid and constituent units (B) derived from 6-hydroxy-2-naphthoic acid, in a molar ratio of 73 mol % (A) to 27 mol % (B). The mass feed ratio of the used liquid crystal polymer filaments to the virgin liquid crystal polymer material was 11:89. Kneading was performed at a temperature of 200 to 400° C., and, after melt-spinning, a 280 dtex/50f yarn was produced. This yarn was heat treated at a temperature of 275° C. for a time of 12 hours.

TABLE 5

| | | | Tensile strength | | Elastic modulus |
|---|---|---|---|---|---|
| Example | Used LCP | Virgin LCP | (cN/dtex) | Elongation % | (cN/dtex) |
| 1 | 11 | 89 | 25.8 | 3.4 | 580 |
| 2 | 45 | 55 | 23.4 | 3.2 | 569 |
| 3 | 100 | 0 | 25.8 | 3.4 | 575 |
| 4 | 10 | 90 | 25.3 | 3.2 | 615 |
| Reference | 0 | 100 | 26.5 | 3.5 | 588 |

As seen in Table 5, the inventive examples (1-4), employing used liquid crystal polymer filaments, had values of tensile strength, elongation %, and elastic modulus that were comparable to the reference example that employed only virgin liquid crystal polymer material. These were unexpected results, in particular for Example 3, which employed entirely used liquid crystal polymer filaments without any virgin liquid crystal polymer material.

The above description is presented to enable a person skilled in the art to make and use the invention and is provided in the context of a particular application and its requirements. Various modifications to the embodiments disclosed herein will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the disclosure may not show every benefit of the invention, considered broadly.

What is claimed is:

1. A method for producing a recycled liquid crystal polymer filament, comprising:
feeding one or more used liquid crystal polymer filaments, optionally in combination with a virgin liquid crystal polymer material, into an extruder; and
extruding the recycled liquid crystal polymer filament.

2. The method of claim 1, wherein a catalyst is not fed into the extruder during the extruding of the recycled liquid crystal polymer filament.

3. The method of claim 1, wherein the virgin liquid crystal polymer material is fed into the extruder in combination with the one or more used liquid crystal polymer filaments.

4. The method of claim 3, wherein a mass feed ratio of the one or more used liquid crystal polymer filaments to the virgin liquid crystal polymer material is in a range of 1:99 to 99:1.

5. The method of claim 3, wherein the virgin liquid crystal polymer material is fed into the extruder in the form of one or more pellets.

6. The method of claim 1, wherein the one or more used liquid crystal polymer filaments have not been heat treated at a temperature of 250° C. or above prior to being fed into the extruder.

7. The method of claim 1, wherein the one or more used liquid crystal polymer filaments have a length of 50% or less of a circumferential length of a screw shaft of the extruder.

8. A method for producing a recycled liquid crystal polymer filament, comprising:
feeding into an extruder (a) one or more used liquid crystal polymer filaments, (b) a depolymerization catalyst, and (c) optionally a virgin liquid crystal polymer material; and
extruding the recycled liquid crystal polymer filament.

9. The method of claim 8, wherein the virgin liquid crystal polymer material is fed into the extruder in combination with the one or more used liquid crystal polymer filaments and the depolymerization catalyst.

10. The method of claim 9, wherein a mass feed ratio of the one or more used liquid crystal polymer filaments to the virgin liquid crystal polymer material is in a range of 1:99 to 99:1.

11. The method of claim 9, wherein the virgin liquid crystal polymer material is fed into the extruder in the form of one or more pellets.

12. The method of claim 8, wherein the one or more used liquid crystal polymer filaments have been heat treated at a temperature of 180° C. or above prior to being fed into the extruder.

13. The method of claim 8, wherein the one or more used liquid crystal polymer filaments have a length of 50% or less of a circumferential length of a screw shaft of the extruder.

14. A recycled liquid crystal polymer filament produced by the method of claim 1.
